(19) United States
(12) Patent Application Publication
(10) Pub. No.: US 2023/0180333 A1
(43) Pub. Date: Jun. 8, 2023

(54) METHOD AND APPARATUS FOR HANDLING PUCCH RESOURCE FOR ENHANCED BEAM FAILURE RECOVERY IN WIRELESS COMMUNICATION SYSTEM

(71) Applicant: Samsung Electronics Co., Ltd., Suwon-si (KR)

(72) Inventors: Anil AGIWAL, Suwon-si (KR); Seungri JIN, Suwon-si (KR)

(21) Appl. No.: 18/073,094

(22) Filed: Dec. 1, 2022

(30) Foreign Application Priority Data
Dec. 8, 2021 (KR) 10-2021-0174979

(51) Int. Cl. H04W 76/19; H04W 72/1268

(52) U.S. Cl. CPC H04W 76/19; H04W 72/1268

(57) ABSTRACT

The disclosure relates to a fifth generation (5G) or sixth generation (6G) communication system for supporting a higher data transmission rate. A method and an apparatus for handling physical uplink control channel (PUCCH) resource for enhanced beam failure recovery (BFR) in wireless communication system are provided.

### CROSS-REFERENCE TO RELATED APPLICATION(S)

This application is based on and claims priority under 35 U.S.C. § 119(a) of a Korean patent application number 10-2021-0174979, filed on Dec. 8, 2021, in the Korean Intellectual Property Office, the disclosure of which is incorporated by reference herein in its entirety.

### BACKGROUND

### 1. Field

The disclosure relates to a wireless communication system (or a mobile communication system). More particularly, the disclosure relates to an apparatus, a method and a system for handling physical uplink control channel (PUCCH) resource for enhanced beam failure recovery (BFR) in wireless communication system.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service-based architecture or service-based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

Recently, there are needs to enhance PUCCH resource handling (or PUCCH resource management) to enhance the beam failure recovery procedure.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

Additional aspects will be set forth in part in the description which follows and, in part, will be apparent from the description, or may be learned by practice of the presented embodiments.

In accordance with an aspect of the disclosure, a method performed by a terminal is provided. The method includes identifying that a first physical uplink control channel (PUCCH) resource for a first pending scheduling request (SR) associated with a beam failure recovery and a second PUCCH resource for a second pending SR different from the first pending SR overlap; and transmitting, to a base station, an SR in one of the first PUCCH resource and the second PUCCH resource, wherein, in case that the first PUCCH resource is for a secondary cell (SCell) beam failure recovery and the second PUCCH resource is not for a beam failure recovery of beam failure detection (BFD) reference signal (RS) set, the SR is transmitted in the first PUCCH resource.

In accordance with another aspect of the disclosure, a terminal is provided. The terminal includes a transceiver; and a controller coupled with the transceiver and configured to: identify that a first physical uplink control channel (PUCCH) resource for a first pending scheduling request (SR) associated with a beam failure recovery and a second PUCCH resource for a second pending SR different from the first pending SR overlap, and transmit, to a base station, an SR in one of the first PUCCH resource and the second PUCCH resource, wherein, in case that the first PUCCH resource is for a secondary cell (SCell) beam failure recovery and the second PUCCH resource is not for a beam failure recovery of beam failure detection (BFD) reference signal (RS) set, the SR is transmitted in the first PUCCH resource.

In accordance with another aspect of the disclosure, a method performed by a base station is provided. The method includes receiving, from a terminal, a scheduling request (SR), wherein, in case that a first physical uplink control channel (PUCCH) resource for a first pending scheduling request (SR) associated with a beam failure recovery and a second PUCCH resource for a second pending SR different from the first pending SR overlap, the SR is received in one of the first PUCCH resource and the second PUCCH resource, and wherein, in case that the first PUCCH resource is for a secondary cell (SCell) beam failure recovery and the second PUCCH resource is not for a beam failure recovery of beam failure detection (BFD) reference signal (RS) set, the SR is received in the first PUCCH resource.

In accordance with another aspect of the disclosure, a base station is provided. The base station includes a transceiver; and a controller coupled with the transceiver and configured to: receive, from a terminal, a scheduling request (SR), wherein, in case that a first physical uplink control channel (PUCCH) resource for a first pending scheduling request (SR) associated with a beam failure recovery and a second PUCCH resource for a second pending SR different from the first pending SR overlap, the SR is received in one of the first PUCCH resource and the second PUCCH resource, and wherein, in case that the first PUCCH resource is for a secondary cell (SCell) beam failure recovery and the second PUCCH resource is not for a beam failure recovery of beam failure detection (BFD) reference signal (RS) set, the SR is received in the first PUCCH resource.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of PUCCH resource overlapping handling according to an embodiment of the disclosure;

FIG. 2 illustrates another example of PUCCH resource overlapping handling according to an embodiment of the disclosure;

FIG. 3 illustrates another example of PUCCH resource overlapping handling according to an embodiment of the disclosure;

FIG. 4 illustrates another example of PUCCH resource overlapping handling according to an embodiment of the disclosure;

FIG. 5 is a block diagram of a terminal according to an embodiment of the disclosure; and

FIG. 6 is a block diagram of a base station according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

Embodiments of the disclosure are described based on 3rd generation partnership project (3GPP) communication system (e.g., a long-term evolution (LTE) communication system or an NR communication system), but the contents of the disclosure are not limited thereto and may be applied in various wireless communication systems for transmitting uplink control information.

The term ‘base station’ may be referred as the ‘access point (AP)’, ‘eNodeB (eNB)’, ‘5th generation node (5G node)’, ‘5G node ratio (5G NodeB, NB)’, ‘ next generation node B (gNB)’, ‘wireless point’, ‘transmission/reception point (TRP)’, ‘distributed unit (DU)’, ‘wireless unit’ (radio unit (RU)), remote radio equipment (remote radio head (RRH)), or may be referred to as another term having an equivalent technical meaning. According to various embodiments, the base station may be connected to one or more TRPs'. The base station may transmit a downlink signal to the terminal or receive an uplink signal through one or more TRPs. In one embodiment, the base station comprises at least one transceiver and at least one processor to perform operations described below.

The base station may be implemented to form an access network having an integrated deployment (e.g., an eNB of LTE), as well as a distributed deployment. In some embodiments, the base station is divided into a central unit (CU) and a digital unit (DU), and the CU is associated with an upper layer function (e.g., packet data convergence protocol (PDCP), radio resource control (RRC)). DU is associated with lower layers (e.g., radio link control (RLC), medium access control (MAC), physical (PHY)). In this way, the base station having the distributed deployment may further include a configuration for fronthaul interface (i.e., F1 interface) communication. According to an embodiment, the base station, as a DU, may perform functions for transmitting and receiving signals in a wired communication environment. The DU may include a wired interface for controlling a direct connection between the device and the device via a transmission medium (e.g., copper wire, optical fiber). For example, the DU may transmit an electrical signal to another device through a copper wire or perform conversion between an electrical signal and an optical signal. One or more DUs may be connected to a CU in a distributed deployment. However, this description is not to be construed as excluding a scenario in which the DU is connected to the CU through a wireless network. In addition, the DU may be additionally connected to a radio unit (RU). However, this description is not to be construed as excluding a radio environment consisting only of CUs and DUs.

The terminal is a device used by a user and performs communication with the base station through a wireless channel. The terminal may be referred as includes ‘user equipment (UE)’, ‘mobile station’, ‘subscriber station’, ‘customer premises equipment’ (CPE), ‘remote terminal’, ‘wireless terminal’, ‘electronic device’, or ‘vehicle (vehicle) terminal’, ‘user device’ or equivalent technical other than a terminal. The terminal may be referred to by other terms that have meaning. In one embodiment, the terminal comprises at least one transceiver and at least one processor to perform operations described below.

Hereinafter, in the disclosure, higher layer signaling or higher signal refers to signal transmitted from the base station to the terminal using the downlink data channel of the physical layer, or from the terminal to the base station using the uplink data channel of the physical layer. According to an embodiment, the higher layer signaling comprises RRC signaling, or signaling according to the F1 interface between a CU and a DU, or a MAC control element (CE) (MAC CE). Also, according to an embodiment, the higher layer signaling or the higher signal may include system information commonly transmitted (i.e., broadcasted) to a one or more UEs, for example, a system information block (SIB).

The fifth generation wireless communication system, supports standalone mode of operation as well as dual connectivity (DC). In DC a multiple reception (Rx)/transmission (Tx) UE may be configured to utilize resources provided by two different nodes (or base stations) connected via non-ideal backhaul. One node acts as the Master Node (MN) and the other as the Secondary Node (SN). The MN and SN are connected via a network interface and at least the MN is connected to the core network. NR also supports Multi-Radio Access Technology Dual Connectivity (MR-DC) operation whereby a UE in RRC CONNECTED is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in RRC CONNECTED not configured with carrier aggregation (CA)/DC there is only one serving cell comprising of the primary cell. For a UE in RRC CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the primary cell (PCell) and optionally one or more secondary cells (SCells). In NR the term Secondary Cell Group (SCG) refers to a group of serving cells associated with the Secondary Node, comprising of the primary SCG cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, SCell is a cell providing additional radio resources on top of Special Cell. PSCell refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

In the fifth generation wireless communication system, Physical Downlink Control Channel (PDCCH) is used to schedule downlink (DL) transmissions on Physical Downlink Shared Channel (PDSCH) and uplink (UL) transmissions on Physical Uplink Shared Channel (PUSCH), where the Downlink Control Information (DCI) on PDCCH includes: Downlink assignments containing at least modulation and coding format, resource allocation, and hybrid automatic repeat request (HARQ) information related to downlink shared channel (DL-SCH); Uplink scheduling grants containing at least modulation and coding format, resource allocation, and hybrid-ARQ information related to uplink shared channel (UL-SCH). In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB(s)) and orthogonal frequency division multiplexing (OFDM) symbol(s) where the UE may assume no transmission is intended for the UE; Transmission of transmission power control (TPC) commands for Physical Uplink Control Channel (PUCCH) and PUSCH; Transmission of one or more TPC commands for sounding reference signal (SRS) transmissions by one or more UEs; Switching a UE's active bandwidth part; Initiating a random access procedure.

A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrate phase shift keying (QPSK) modulation is used for PDCCH.

In fifth generation wireless communication system, a list of search space configurations is signaled by gNB for each configured bandwidth part (BWP) wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+ duration where the slot with number ‘x’ in a radio frame with number ‘y’ satisfies the Equation 1 below:

(y*(number of slots in a radio frame)+x−Monitoring-offset-PDCCH-slot) mod (Monitoring-periodicity-PDCCH-slot)=0 Equation 1

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations is signaled by gNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of Transmission configuration indicator (TCI) states. One DL RS identifier (ID) (e.g., synchronization signal and physical broadcast channel (PBCH) block (SSB) or channel state information (CSI) reference signal (RS)) is configured per TCI state. The list of TCI states corresponding to a coreset configuration is signaled by gNB via RRC signaling. One of the TCI states in TCI state list is activated and indicated to UE by gNB. TCI state indicates the DL TX beam (DL TX beam is quasi-co-located (QCLed) with SSB/CSI-RS of TCI state) used by GNB for transmission of PDCCH in the PDCCH monitoring occasions of a search space.

In this specification, the term ‘beam’ refers to a spatial flow of a signal in a radio channel, and is formed by one or more antennas (or antenna elements), and this formation process may be referred to as beamforming. In some embodiments, an antenna array in which a plurality of antenna elements are concentrated may be used, and in this case, a shape (i.e., coverage) according to a signal gain may have a direction. A beam used for transmission of a signal may be referred to as a transmission beam or a beam used for reception of a signal may be referred to as a reception beam.

When a device (e.g., base station or terminal) transmits a signal in the direction of a transmission beam, the signal gain of the device may increase. When a signal is transmitted using a transmission beam, a signal may be transmitted through a spatial domain transmission filter of a side that transmits the signal, that is, a transmission end. When transmitting a signal using a plurality of transmission beams, the transmitting end may transmit the signal while changing a spatial domain transmission filter. For example, when transmitting using the same transmission beam, the transmitting end may transmit a signal through the same spatial domain transmission filter. For example, when the UE receives CSI-RSs for reception beam discovery, the UE has the same (same) spatial domain transmission filter (spatial)).

When a device (e.g., base station or terminal) receives a signal in the direction of a reception beam, the signal gain of the device may increase. When a signal is transported using a reception beam, a signal may be received through a side receiving the signal, that is, a spatial domain reception filter of the receiving end. For example, when the terminal simultaneously receives multiple signals transmitted using different beams, the terminal receives the signals using a single spatial domain receive filter or multiple simultaneous spatial domains. The signals may be received using multiple simultaneous spatial domain receive filters.

In addition, as a signal transmitted using the beam in the disclosure, a reference signal may be used, for example, a DMRS, a CSI-RS, the signal may include a SS/PBCH and an SRS. In addition, as a configuration for each reference signal, an information element (IE) such as a CSI-RS resource or an SRS-resource may be used, and this configuration may include information associated with a beam. The information related to the beam is whether the configuration (e.g., CSI-RS resource) uses the same spatial domain filter as the other configuration (e.g., another CSI-RS resource in the same CSI-RS resource set) or is different. It may mean whether a spatial domain filter is used, or which reference signal is quasi-co-located (QCL), and if it is QCL, which type (e.g., QCL type A, B, C, D). The QCL type may be defined as follows. According to various embodiments, the QCL type and the associated reference resource (e.g., CSI-RS resource or SSB resource) are configured as ‘TCI state’. The TCI state associates reference signals with a corresponding quasi-colocation (QCL) type.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The terminal may measure the quality of the beam in order to measurements (e.g., the cell quality or the BWP quality). The UE may obtain the beam quality based on the CSI-RS or SS/PBCH block.

In fifth generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a BWP. BA is achieved by configuring RRC connected UE with BWP(s) and telling the UE which of the configured BWPs is currently the active one. When BA is configured, the UE only has to monitor PDCCH on the one active BWP i.e., it does not have to monitor PDCCH on the entire DL frequency of the serving cell. In RRC connected state, UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the 5G wireless communication system, random access (RA) is supported. Random access (RA) is used to achieve UL time synchronization. RA is used during initial access, handover, RRC connection re-establishment procedure, scheduling request transmission, SCG addition/modification, beam failure recovery and data or control information transmission in UL by non-synchronized UE in RRC CONNECTED state. Several types of random access procedure is supported.

Contention based random access (CBRA): This is also referred as 4 step CBRA. In this type of random access, UE first transmits Random Access preamble (also referred as Msg1) and then waits for Random access response (RAR) in the RAR window. RAR is also referred as Msg2. Next generation node B (gNB) transmits the RAR on PDSCH. PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH TX occasion or RA channel (RACH) occasion) in which RA preamble was detected by gNB. The RA-RNTI is calculated as follows: RA-RNTI=1+s_id+14*t_id+14*80*f_id+14*80*8*ul_carrier_id, where s_id is the index of the first OFDM symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg 1 transmission (0 for normal UL (NUL) carrier and 1 for supplementary UL (SUL) carrier. Several RARs for various Random access preambles detected by gNB can be multiplexed in the same RAR MAC protocol data unit (PDU) by gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and UE has not yet transmitted the RA preamble for a configurable (configured by gNB in RACH configuration) number of times, the UE goes back to first step i.e. select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, SI request etc. It may include the UE identity (i.e. cell-radio network temporary identifier (C-RNTI) or system architecture evolution (SAE)-temporary mobile subscriber identity (S-TMSI) or a random number). After transmitting the Msg3, UE starts a contention resolution timer. While the contention resolution timer is running, if UE receives a physical downlink control channel (PDCCH) addressed to C-RNTI included in Msg3, contention resolution is considered successful, contention resolution timer is stopped and RA procedure is completed. While the contention resolution timer is running, if UE receives contention resolution MAC CE including the UE's contention resolution identity (e.g., first X bits of common control channel (CCCH) service data unit (SDU) transmitted in Msg3), contention resolution is considered successful, contention resolution timer is stopped and RA procedure is completed. If the contention resolution timer expires and UE has not yet transmitted the RA preamble for a configurable number of times, UE goes back to first step i.e. select random access resource (preamble/RACH occasion) and transmits the RA preamble. A backoff may be applied before going back to first step.

Contention free random access (CFRA): This is also referred as legacy CFRA or 4 step CFRA. CFRA procedure is used for scenarios such as handover where low latency is required, timing advance establishment for SCell, etc. Base station assigns to UE dedicated Random access preamble. UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to contention-based RA (CBRA) procedure. CFRA is considered successfully completed after receiving the RAR including RA preamble identifier (RAPID) of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and UE has not yet transmitted the RA preamble for a configurable (configured by gNB in RACH configuration) number of times, the UE retransmits the RA preamble.

For certain events such has handover and beam failure recovery if dedicated preamble(s) are assigned to UE, during first step of random access i.e. during random access resource selection for Msg1 transmission UE determines whether to transmit dedicated preamble or non-dedicated preamble. Dedicated preambles are typically provided for a subset of SSBs/CSI-RSs. If there is no SSB/CSI RS having DL RSRP above a threshold amongst the SSBs/CSI RSs for which contention free random access resources (i.e. dedicated preambles/ROs) are provided by gNB, UE select non dedicated preamble. Otherwise, UE select dedicated preamble. During the RA procedure, one random access attempt can be CFRA while other random access attempt can be CBRA.

2 step contention based random access (2 step CBRA): In the first step, UE transmits random access preamble on PRACH and a payload (i.e. MAC PDU) on PUSCH. The random access preamble and payload transmission is also referred as MsgA. In the second step, after MsgA transmission, the UE monitors for a response from the network (i.e. gNB) within a configured window. The response is also referred as MsgB. If CCCH SDU was transmitted in MsgA payload, UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, UE transmits Msg3 and performs contention resolution using Msg4 as in CBRA procedure. If contention resolution is successful, random access procedure is considered successfully completed. If contention resolution fails upon fallback (i.e., upon transmitting Msg3), UE retransmits MsgA. If configured window in which UE monitor network response after transmitting MsgA expires and UE has not received MsgB including contention resolution information or fallback information as explained above, UE retransmits MsgA. If the random access procedure is not successfully completed even after transmitting the MsgA configurable number of times, UE fallbacks to 4 step RACH procedure i.e. UE only transmits the PRACH preamble.

MsgA payload may include one or more of CCCH SDU, dedicated control channel (DCCH) SDU, dedicated traffic channel (DTCH) SDU, buffer status report (BSR) MAC CE, power headroom report (PHR) MAC CE, SSB information, C-RNTI MAC CE, or padding. MsgA may include UE ID (e.g., random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc. The UE ID can be different in different scenarios in which UE performs the RA procedure. When UE performs RA after power on (before it is attached to the network), then UE ID is the random ID. When UE perform RA in IDLE state after it is attached to network, the UE ID is S-TMSI. If UE has an assigned C-RNTI (e.g. in connected state), the UE ID is C-RNTI. In case UE is in INACTIVE state, UE ID is resume ID. In addition to UE ID, some addition ctrl information can be sent in MsgA. The control information may be included in the MAC PDU of the MsgA. The control information may include one or more of connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA): In this case gNB assigns to UE dedicated Random access preamble (s) and PUSCH resource(s) for MsgA transmission. RO(s) to be used for preamble transmission may also be indicated. In the first step, UE transmits random access preamble on PRACH and a payload on PUSCH using the contention free random access resources (i.e. dedicated preamble/PUSCH resource/RO). In the second step, after MsgA transmission, the UE monitors for a response from the network (i.e. gNB) within a configured window. If UE receives PDCCH addressed to C-RNTI, random access procedure is considered successfully completed. If UE receives fallback information corresponding to its transmitted preamble, random access procedure is considered successfully completed.

For certain events such has handover and beam failure recovery if dedicated preamble(s) and PUSCH resource(s) are assigned to UE, during first step of random access i.e. during random access resource selection for MsgA transmission UE determines whether to transmit dedicated preamble or non-dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e. dedicated preambles/ROs/PUSCH resources) are provided by gNB, UE select non dedicated preamble. Otherwise, UE select dedicated preamble. So, during the RA procedure, one random access attempt can be 2 step CFRA while other random access attempt can be 2 step CBRA.

Upon initiation of random access procedure, UE first selects the carrier (SUL or NUL). If the carrier to use for the Random Access procedure is explicitly signaled by gNB, UE select the signaled carrier for performing Random Access procedure. If the carrier to use for the Random Access procedure is not explicitly signaled by gNB; and if the Serving Cell for the Random Access procedure is configured with supplementary uplink and if the RSRP of the downlink pathloss reference is less than rsrp-ThresholdSSB-SUL: UE select the SUL carrier for performing Random Access procedure. Otherwise, UE select the NUL carrier for performing Random Access procedure. Upon selecting the UL carrier, UE determines the UL and DL BWP for random access procedure. UE then determines whether to perform 2 step or 4 step RACH for this random access procedure.
If this random access procedure is initiated by PDCCH order and if the ra-PreambleIndex explicitly provided by PDCCH is not Ob000000, UE selects 4 step RACH.
else if 2 step contention free random access resources are signaled by gNB for this random access procedure, UE selects 2 step RACH.
else if 4 step contention free random access resources are signaled by gNB for this random access procedure, UE selects 4 step RACH.
else if the UL BWP selected for this random access procedure is configured with only 2 step RACH resources, UE selects 2 step RACH.
else if the UL BWP selected for this random access procedure is configured with only 4 step RACH resources, UE selects 4 step RACH.
else if the UL BWP selected for this random access procedure is configured with both 2 step and 4 step RACH resources,
   if RSRP of the downlink pathloss reference is below a configured threshold, UE selects 4 step RACH. Otherwise, UE selects 2 step RACH.

In the fifth generation wireless communication system, RRC can be in one of the following states: RRC_IDLE, RRC_INACTIVE, and RRC_CONNECTED. A UE is either in RRC_CONNECTED state or in RR_INACTIVE state when an RRC connection has been established. If this is not the case, i.e. no RRC connection is established, the UE is in RRC_IDLE state. The RRC states can further be characterized as follows:

In the RRC_IDLE, a UE specific DRX may be configured by upper layers. The UE monitors Short Messages transmitted with P-RNTI over DCI; monitors a Paging channel for CN paging using 5G-S-TMSI; performs neighboring cell measurements and cell (re-)selection; acquires system information and can send SI request (if configured); performs logging of available measurements together with location and time for logged measurement configured UEs.

In RRC_INACTIVE, a UE specific DRX may be configured by upper layers or by RRC layer; UE stores the UE Inactive AS context; a RAN-based notification area is configured by RRC layer. The UE monitors Short Messages transmitted with P-RNTI over DCI; monitors a Paging channel for CN paging using 5G-S-TMSI and RAN paging using full I-RNTI; performs neighboring cell measurements and cell (re-)selection; performs RAN-based notification area updates periodically and when moving outside the configured RAN-based notification area; acquires system information and can send SI request (if configured); performs logging of available measurements together with location and time for logged measurement configured UEs.

In the RRC_CONNECTED, the UE stores the AS context and transfer of unicast data to/from UE takes place. The UE monitors Short Messages transmitted with P-RNTI over DCI, if configured; monitors control channels associated with the shared data channel to determine if data is scheduled for it; provides channel quality and feedback information; performs neighboring cell measurements and measurement reporting; acquires system information.

In the RRC_CONNECTED, network may initiate suspension of the RRC connection by sending RRCRelease with suspend configuration. When the RRC connection is suspended, the UE stores the UE Inactive AS context and any configuration received from the network, and transits to RRC_INACTIVE state. If the UE is configured with SCG, the UE releases the SCG configuration upon initiating a RRC Connection Resume procedure. The RRC message to suspend the RRC connection is integrity protected and ciphered.

The resumption of a suspended RRC connection is initiated by upper layers when the UE needs to transit from RRC INACTIVE state to RRC_CONNECTED state or by RRC layer to perform an RNA update or by RAN paging from NG-RAN. When the RRC connection is resumed, network configures the UE according to the RRC connection resume procedure based on the stored UE Inactive AS context and any RRC configuration received from the network. The RRC connection resume procedure re-activates AS security and re-establishes signaling radio bearer(s) (SRB(s)) and data radio bearer(s) (DRB(s)). In response to a request to resume the RRC connection, the network may resume the suspended RRC connection and send UE to RRC_CONNECTED, or reject the request to resume and send UE to RRC_INACTIVE (with a wait timer), or directly re-suspend the RRC connection and send UE to RRC_INACTIVE, or directly release the RRC connection and send UE to RRC_IDLE, or instruct the UE to initiate NAS level recovery (in this case the network sends an RRC setup message).

The fifth generation wireless communication system supports beam failure detection (BFD) and beam failure recovery (BFR) mechanism at UE for serving cell. This comprises of beam failure detection, new candidate beam identification, beam failure recovery request transmission and monitoring response for beam failure recovery request. For beam failure detection of a serving cell, UE is configured with a list of beam failure detection RSs (SSB or CSI-RS based) for that serving cell. UE monitors these RSs periodically. A beam failure is detected on a serving cell if number of consecutive detected beam failure instance exceeds a configured maximum number (beamFailureInstanceMaxCount) within a configured time (beamFailureDetectionTimer). A Beam Failure Instance means that hypothetical PDCCH BLER (block error rate) determined based on measurement of beam failure detection RS is above a threshold for all beam failure detection RSs. Beam failure detection may be configured for zero or one or more serving cells. Upon beam failure instance, lower layer (i.e. physical) sends indication to MAC. The MAC entity in UE for each Serving Cell configured for beam failure detection, perform the following operation:

1> if beam failure instance indication has been received from lower layers:
2> start or restart the beamFailureDetectionTimer;
2> increment BFI COUNTER by 1;
2> if BFI_COUNTER>=beamFailureInstanceMaxCount:
   3> if the Serving Cell is SCell:
      4> trigger a BFR for this Serving Cell;
   3> else:
      4> initiate a Random Access procedure on the SpCell.

1> if the beamFailureDetectionTimer expires; or

1> if beamFailureDetectionTimer, beamFailureInstanceMaxCount, or any of the reference signals used for beam failure detection is reconfigured by upper layers (i.e. RRC) associated with this Serving Cell:
2> set BFI COUNTER to 0.

1> if the Serving Cell is SpCell and the Random Access procedure initiated for SpCell beam failure recovery is successfully completed:
2> set BFI COUNTER to 0;
2> stop the beamFailureRecoveryTimer, if configured;
2> consider the Beam Failure Recovery procedure successfully completed.

1> else if the Serving Cell is SCell, and a PDCCH addressed to C-RNTI indicating uplink grant for a new transmission is received for the HARQ process used for the transmission of the BFR MAC CE or Truncated BFR MAC CE which contains beam failure recovery information of this Serving Cell; or

1> if the SCell is deactivated:
2> set BFI COUNTER to 0;
2> consider the Beam Failure Recovery procedure successfully completed and cancel all the triggered BFRs for this Serving Cell.

The MAC entity shall:

1> if the Beam Failure Recovery procedure determines that at least one BFR has been triggered and not cancelled:
2> if UL-SCH resources are available for a new transmission and if the UL-SCH resources can accommodate the BFR MAC CE plus its subheader as a result of LCP:
   3> instruct the Multiplexing and Assembly procedure to generate the BFR MAC CE.
2> else if UL-SCH resources are available for a new transmission and if the UL-SCH resources can accommodate the Truncated BFR MAC CE plus its subheader as a result of LCP:
   3> instruct the Multiplexing and Assembly procedure to generate the Truncated BFR MAC CE.
2> else:
   3> trigger the scheduling request (SR) for SCell beam failure recovery for each SCell for which BFR has been triggered and not cancelled.

All BFRs triggered prior to MAC PDU assembly for beam failure recovery for an SCell shall be cancelled when a MAC PDU is transmitted and this PDU includes a BFR MAC CE or Truncated BFR MAC CE which contains beam failure information of that SCell.

Parameters including beamFailureInstanceMaxCount, beamFailureDetectionTimer, beamFailureRecoveryTimer for the beam failure recovery procedure are specific to serving cell. BFI_COUNTER is maintained separately for each serving cell configured with beam failure detection.

The MAC CEs for BFR consists of either:
BFR MAC CE; or
Truncated BFR MAC CE.

The BFR MAC CE and Truncated BFR MAC CE are identified by a MAC subheader with LCID/eLCID.

The BFR MAC CE and Truncated BFR MAC CE have a variable size. They include a bitmap and in ascending order based on the ServCellIndex, beam failure recovery information i.e. octets containing candidate beam availability indication (AC) for SCells indicated in the bitmap. For BFR MAC CE, a single octet bitmap is used when the highest ServCellIndex of this MAC entity's SCell for which beam failure is detected is less than 8, otherwise four octets are used. A MAC PDU shall contain at most one BFR MAC CE.

For Truncated BFR MAC CE, a single octet bitmap is used for the following cases, otherwise four octets are used:
the highest ServCellIndex of this MAC entity's SCell for which beam failure is detected is less than 8; or
beam failure is detected for SpCell and the SpCell is to be indicated in a Truncated BFR MAC CE and the UL-SCH resources available for transmission cannot accommodate the Truncated BFR MAC CE with the four octets bitmap plus its subheader as a result of LCP.

The fields in the BFR MAC CEs are defined as follows:
SP: This field indicates beam failure detection for the SpCell of this MAC entity. The SP field is set to 1 to indicate that beam failure is detected for SpCell only when BFR MAC CE or Truncated BFR MAC CE is to be included into a MAC PDU as part of Random Access Procedure, otherwise, it is set to 0;
Cᵢ (BFR MAC CE): This field indicates beam failure detection and the presence of an octet containing the AC field for the SCell with ServCellIndex i. The Cᵢ field set to 1 indicates that beam failure is detected and the octet containing the AC field is present for the SCell with ServCellIndex i. The Cᵢ field set to 0 indicates that the beam failure is not detected and octet containing the AC field is not present for the SCell with ServCellIndex i. The octets containing the AC field are present in ascending order based on the ServCellIndex;
Cᵢ (Truncated BFR MAC CE): This field indicates beam failure detection for the SCell with ServCellIndex i. The Cᵢ field set to 1 indicates that beam failure is detected and the octet containing the AC field for the SCell with ServCellIndex i may be present. The Cᵢ field set to 0 indicates that the beam failure is not detected and the octet containing the AC field is not present for the SCell with ServCellIndex i. The octets containing the AC field, if present, are included in ascending order based on the ServCellIndex. The number of octets containing the AC field included is maximized, while not exceeding the available grant size;
AC: This field indicates the presence of the Candidate RS ID field in this octet. If at least one of the SSBs with SS-RSRP above rsrp-ThresholdBFR amongst the SSBs in candidateBeamRSSCellList or the CSI-RSs with CSI-RSRP above rsrp-ThresholdBFR amongst the CSI-RSs in candidateBeamRSSCellList is available, the AC field is set to 1; otherwise, it is set to 0. If the AC field set to 1, the Candidate RS ID field is present. If the AC field set to 0, R bits are present instead;
Candidate RS ID: This field is set to the index of an SSB with SS-RSRP above rsrp-ThresholdBFR amongst the SSBs in candidateBeamRSSCellList or to the index of a CSI-RS with CSI-RSRP above rsrp-ThresholdBFR amongst the CSI-RSs in candidateBeamRSSCellList. The length of this field is 6 bits.
R: Reserved bit, set to 0.

The fifth generation wireless communication system supports beam failure detection and recovery mechanism at UE for TRP(s) of serving cell. A serving cell can support multiple transmission/reception points (TRPs) and UE can be served with multiple TRPs concurrently for improved data rate and reliability. BFD/BFR is performed per TRP. Separate BFD-RS set and candidate beam list for each TRP is signaled by gNB. BFI COUNTER is maintained separately for each TRP of serving cell. A beam failure is detected for a TRP of a serving cell if number of consecutive detected beam failure instance for the TRP exceeds a configured maximum number (beamFailureInstanceMaxCount) within a configured time (beamFailureDetectionTimer). beamFailureDetectionTimer and beamFailureInstanceMaxCount is configured/signaled by gNB separately for each TRP of serving cell. beamFailureDetectionTimer is configured/signaled by gNB separately for each TRP of serving cell. beamFailureInstanceMaxCount is configured/signaled by gNB separately for each TRP of serving cell. A Beam Failure Instance for a TRP means that hypothetical PDCCH BLER (block error rate) determined based on measurement of beam failure detection RS is above a threshold for all beam failure detection RSs in BFD-RS set of the TRP. Upon beam failure instance for a TRP, lower layer i.e. PHY (physical) sends indication to MAC. MAC entity in UE performs the following operation for serving cell configured with multiple BFD-RS sets:

1> if the Serving Cell is configured with multiple BFD-RS sets, the MAC entity shall for each BFD-RS set of this Serving Cell:
2> if beam failure instance indication for a BFD-RS set has been received from lower layers:
   3> start or restart the beamFailureDetectionTimer corresponding to the BFD-RS set;
   3> increment BFI_COUNTER corresponding to the BFD-RS set by 1;
   3> if BFI COUNTER>=beamFailureInstanceMaxCount:
      4> trigger a BFR for this BFD-RS set of the Serving Cell;
2> if BFR for both BFD-RS sets of the Serving Cell are triggered and pending (i.e. not cancelled or not successfully completed):
   3> if the Serving Cell is SpCell:
      4> initiate a Random Access procedure on the SpCell;
      4> if the initiated Random Access procedure is successfully completed:
         5> set BFI_COUNTER of each BFD-RS set of SpCell to 0.
2> if the beamFailureDetectionTimer of this BFD-RS set expires; or
2> if beamFailureDetectionTimer, beamFailureInstanceMaxCount, or any of the reference signals used for beam failure detection is reconfigured by upper layers associated with this BFD-RS set of the Serving Cell:
   3> set BFI_COUNTER corresponding to the BFD-RS set to 0.
2> if a PDCCH addressed to C-RNTI indicating uplink grant for a new transmission is received for the HARQ process used for the transmission of the Enhanced BFR MAC CE or Truncated Enhanced BFR MAC CE which contains beam failure recovery information of this BFD-RS set of the Serving Cell; or
2> if the SCell is deactivated:
   3> set BFI_COUNTER corresponding to the BFD-RS set to 0;

1> if the Beam Failure Recovery procedure determines that at least one BFR for BFD-RS set has been triggered and not cancelled for an SCell for which evaluation of the candidate beams has been completed; or

1> if the Beam Failure Recovery procedure determines that at least one BFR for BFD-RS set for only one BFD-RS set has been triggered and not cancelled for an SpCell for which evaluation of the candidate beams has been completed:
2> if UL-SCH resources are available for a new transmission and if the UL-SCH resources can accommodate the Enhanced BFR MAC CE plus its sub header as a result of LCP:
   3> instruct the Multiplexing and Assembly procedure to generate the Enhanced BFR MAC CE.
2> else if UL-SCH resources are available for a new transmission and if the UL-SCH resources can accommodate the Truncated Enhanced BFR MAC CE plus its sub header as a result of LCP:
   3> instruct the Multiplexing and Assembly procedure to generate the Truncated Enhanced BFR MAC CE.
2> else:
   3> trigger the SR for beam failure recovery of each BFD-RS set for which BFR has been triggered, not cancelled, and for which evaluation of the candidate beams has been completed. Note that one or two set of PUCCH resources for beam failure recovery of TRP i.e. BFD-RS set is signaled by gNB per cell group. If two set of PUCCH resources are configured, each set of the PUCCH resource can be mapped to one of the TRP(s), mapping between PUCCH resource and TRP (i.e. BFD-RS set) can be signaled by gNB. SR configuration (i.e. SR prohibit timer, sr-TransMax) can be common for both TRPs i.e. BFD-RS sets or can be separately configured for each TRP. If SR configuration is common, it can indicate up to two sets of PUCCH resources by including up to two schedulingRequestIds. Each schedulingRequestId correspond to a SchedulingRequestResourceConfig which indicates periodicityAndOffset and resource field. If SR configuration is different for different TRP i.e. BFD-RS set, it indicates one set of PUCCH resource by including one schedulingRequestId. A set of PUCCH resources is indicated by periodicityAndOffset and resource field. periodicityAndOffset indicates SR i.e. PUCCH resource periodicity and offset in number of symbols or slots. resource indicates ID of the PUCCH resource in which the UE shall send the scheduling request. The actual PUCCH-Resource (id of PUCCH resource, starting PRB, PUCCH format, etc.) is configured in PUCCH-Config of the UL BWP.

All BFRs triggered for a BFD-RS set of an SCell shall be cancelled when a MAC PDU is transmitted and this PDU includes an Enhanced BFR MAC CE or Truncated Enhanced BFR MAC CE which contains beam failure recovery information of that BFD-RS set of the SCell.

Hereinafter, embodiments for handling (or managing) the overlapping of PUCCH resources according to following scenarios will be described.
Scenario 1: PUCCH resource for BSR (buffer status report)/LBT (listen-before-talk) failure can overlap with PUCCH resource for M-TRP (multiple-TRP) BFR i.e. BFR for BFD-RS set of a serving cell.
Scenario 2: PUCCH resource for SCell beam failure recovery can overlap with PUCCH resource for i.e. BFR for BFD-RS set of a serving cell.

### EXAMPLE 1

Multiple TRPs (M-TRP) can be there in a serving cell. That is, a serving cell can be provided to a UE through multiple TRPs. BFD/BFR is performed per TRP. In a serving cell supporting multiple TRPs, separate BFD-RS (reference signal) set (or BFD-RSs) and separate candidate beam list for each TRP is signaled by gNB. BFD-RS set refers to BFD-RSs which the UE measures for beam failure detection. A beam failure is detected for a TRP (i.e. via a BFD-RS set) of a serving cell if number of consecutive detected beam failure instances for the TRP (i.e. via a BFD-RS set) exceeds a configured maximum number (e.g., beamFailureInstanceMaxCount) within a configured time (e.g., beamFailureDetectionTimer). Parameters including beamFailureDetectionTimer and beamFailureInstanceMaxCount are configured/signaled by gNB separately for each TRP (i.e. BFD-RS set) of serving cell. BeamFailureDetectionTimer is configured/signaled by gNB separately for each TRP (i.e. BFD-RS set) of serving cell. BeamFailureInstanceMaxCount is configured/signaled by gNB separately for each TRP (i.e. BFD-RS set) of serving cell. A beam failure instance for a TRP (i.e. BFD-RS set) means that hypothetical PDCCH BLER (block error rate) determined based on measurement of beam failure detection RS is above a threshold for all beam failure detection RSs of the TRP (i.e. BFD-RS set). Upon beam failure instance for a TRP (i.e. BFD-RS set), lower layer i.e. PHY (physical) sends indication to MAC indicating beam failure instance for the TRP (i.e., BFD-RS set). MAC entity in UE performs the following operation for each serving cell configured with multiple TRPs i.e. BFD-RS sets (note that beam failure detection is not performed for SCells (other than PSCell) of SCG when SCG state is deactivated).

The MAC entity shall for each Serving Cell configured for beam failure detection:

1> if the Serving Cell is configured with multiple BFD-RS sets, the MAC entity shall for each BFD-RS set of this Serving Cell:
2> if beam failure instance indication for a BFD-RS set has been received from lower layers:
   3> start or restart the beamFailureDetectionTimer corresponding to the BFD-RS set;
   3> increment BFI COUNTER corresponding to the BFD-RS set by 1;
   3> if BFI_COUNTER corresponding to the BFD-RS set>=beamFailureInstanceMaxCount:
      4> if the Serving Cell is PSCell:
         5> trigger a BFR for this BFD-RS set of the Serving Cell, if SCG is activated (i.e. scg-State of SCG is set to activated in the SCG configuration); In an embodiment, if SCG is deactivated, UE can send information via MCG (to MgNB) that beam failure is detected for BFD-RS set (s) of PSCell. BFD-RS set can be informed. Candidate RS ID corresponding to failed BFD-RS set can also be informed. Information can be sent using MAC CE or RRC message. MgNB can then coordinate with SgNB to update the configuration (e.g. TCI state, BFD-RSs etc) or activate SCG.
      4> else:
         5> trigger a BFR for this BFD-RS set of the Serving Cell;
2> if BFR for both BFD-RS sets of the Serving Cell are triggered and pending (i.e. not cancelled or not successfully completed for any of the BFD-RS sets):
   3> if the Serving Cell is PCell:
      4> initiate a Random Access procedure on the SpCell;
      4> cancel the pending SR triggered for BFR of a BFD-RS set of SpCell and stop the corresponding sr-ProhibitTimer, if running. (Note that at time instance T1, BFR for one BFD-RS set is triggered and SR may be triggered if UL SCH resources are not available or if UL SCH resources are available but it cannot accommodate neither enhanced BFR MAC CE not truncated enhanced BFR MAC CE. Later at time instance T2, BFR for BFR for another BFD-RS set is triggered while the BFR for first BFD-RS set is still pending. In this case UE will RA procedure and cancel the pending SR).
   3> if the Serving Cell is PSCell and SCG is activated (i.e. scg-State of SCG is set to activated in the SCG configuration):
      4> initiate a Random Access procedure on the SpCell;
      4> cancel the pending SR triggered for BFR of a BFD-RS set of SpCell and stop the corresponding sr-ProhibitTimer, if running. (Note that at time instance T1, BFR for one BFD-RS set is triggered and SR may be triggered if UL SCH resources are not available or if UL SCH resources are available but it cannot accommodate neither enhanced BFR MAC CE not truncated enhanced BFR MAC CE. Later at time instance T2, BFR for BFR for another BFD-RS set is triggered while the BFR for first BFD-RS set is still pending. In this case UE will RA procedure and cancel the pending SR).
2> if the serving cell is SpCell and the Random Access procedure initiated triggered by BFR for both BFD-RS sets of the SpCell is successfully completed:
   3> set BFI COUNTER of each BFD-RS set of SpCell to 0.
   3> beam failure recovery procedure is successfully completed.
2> if the beamFailureDetectionTimer of this BFD-RS set expires; or
2> if beamFailureDetectionTimer, beamFailureInstanceMaxCount, or any of the reference signals used for beam failure detection is reconfigured by upper layers associated with this BFD-RS set of the Serving Cell:
   3> set BFI_COUNTER corresponding to the BFD-RS set to 0.
2> if a PDCCH addressed to C-RNTI indicating uplink grant for a new transmission is received for the HARQ process used for the transmission of the Enhanced BFR MAC CE or Truncated Enhanced BFR MAC CE which contains beam failure recovery information of this BFD-RS set of the Serving Cell; or
2> if the serving cell is SpCell and the SCell is deactivated (upon receiving deactivation command from gNB or sCellDeactivationTimer is expired or SCG state is set to deactivated in SCG configuration received from gNB in RRCReconfiguration message):
   3> set BFI_COUNTER corresponding to the BFD-RS set to 0;

1> If SCG is deactivated i.e. SCG state is set to deactivated in SCG configuration received from gNB in RRCReconfiguration message, MAC entity of SCG:
For each SCell configured with multiple BFD-RS sets, set BFI COUNTER corresponding to each BFD-RS set to 0, stop beamFailureDetectionTimer corresponding to each BFD-RS set.
For each Scell not configured with BFD-RS set, set BFI_COUNTER of SCell to 0, beamFailureDetectionTimer.
For PSCell configured with multiple BFD-RS sets, BFI_COUNTER is not set to zero for each BFD-RS set, beamFailureDetectionTimer corresponding to each BFD-RS set is not stopped. In an alternate embodiment, For PSCell configured with multiple BFD-RS sets, BFI_COUNTER is set to zero for each BFD-RS set, beamFailureDetectionTimer corresponding to each BFD-RS set is stopped.
For PSCell not configured with multiple BFD-RS sets, BFI_COUNTER for PSCell is not set to 0, beamFailureDetectionTimer for PSCell is not stopped. In an alternate embodiment, For PSCell not configured with multiple BFD-RS sets, BFI_COUNTER for PSCell is set to 0, beamFailureDetectionTimer for PSCell is stopped.

1> if the Beam Failure Recovery procedure determines that at least one BFR for BFD-RS set has been triggered and not cancelled for an SCell for which evaluation of the candidate beams has been completed; or

1> if the Beam Failure Recovery procedure determines that at least one BFR for BFD-RS set for only one BFD-RS set has been triggered and not cancelled for an SpCell for which evaluation of the candidate beams has been completed:
2> if UL-SCH resources are available for a new transmission and if the UL-SCH resources can accommodate the Enhanced BFR MAC CE plus its sub header as a result of LCP:
   3> instruct the Multiplexing and Assembly procedure to generate the Enhanced BFR MAC CE.
2> else if UL-SCH resources are available for a new transmission and if the UL-SCH resources can accommodate the Truncated Enhanced BFR MAC CE plus its sub header as a result of LCP:
   3> instruct the Multiplexing and Assembly procedure to generate the Truncated Enhanced BFR MAC CE.
2> else:
   3> trigger the SR for beam failure recovery of each BFD-RS set for which BFR has been triggered, not cancelled, and for which evaluation of the candidate beams has been completed.

The MAC entity shall for each pending SR not triggered according to the BSR procedure for a Serving Cell:

1> if this SR was triggered by Pre-emptive BSR procedure prior to the MAC PDU assembly and a MAC PDU containing the relevant Pre-emptive BSR MAC CE is transmitted; or

1> if this SR was triggered by beam failure recovery of an SCell and a MAC PDU is transmitted and this PDU includes a BFR MAC CE or a Truncated BFR MAC CE which contains beam failure recovery information for this SCell; or

1> if this SR was triggered by beam failure recovery for a BFD-RS set of a Serving Cell and a MAC PDU is transmitted and this PDU includes an Enhanced BFR MAC CE or a Truncated Enhanced BFR MAC CE which contains beam failure recovery information for this BFD-RS set of the Serving Cell; or

1> if this SR was triggered by beam failure recovery of an SCell and this SCell is deactivated; or

1> if this SR was triggered by beam failure recovery for a BFD-RS set of an SCell and this SCell is deactivated; or

1> if this SR was triggered by beam failure recovery for a BFD-RS set of a PSCell and SCG is deactivated (i.e. UE receives MAC CE or RRC Reconfiguration message indicating SCG is deactivated); or

1> if this SR was triggered by consistent LBT failure recovery of an SCell and a MAC PDU is transmitted and the MAC PDU includes an LBT failure MAC CE that indicates consistent LBT failure for this SCell; or

1> if this SR was triggered by consistent LBT failure recovery of an SCell and all the triggered consistent LBT failure(s) for this SCell are cancelled:
2> cancel the pending SR and stop the corresponding sr-ProhibitTimer, if running.

The (truncated) BFR MAC CE includes beam failure recovery information of the serving cell i.e. candidate beam availability indication for beam failure recovery of the serving cell and candidate RS ID of the serving cell if candidate beam is available. The (truncated) Enhanced BFR MAC CE includes beam failure recovery information of the failed TRPs (i.e. BFD-RS sets) of the serving cell. Beam failure recovery information of each failed TRP (i.e. BFD-RS set) consists of candidate beam availability indication for beam failure recovery of the TRP of serving cell, BFD-RS set ID and candidate RS ID of the of the failed TRP of serving cell serving cell if candidate beam is available. In case of truncated BFR MAC CE, beam failure recovery information for one or more serving cells for which beam failure is detected and evaluation of candidate beam is completed, can be skipped if UL grant is not enough. In case of truncated enhanced BFR MAC CE, beam failure recovery information for one or more BFD-RS sets (or TRPs) of one or more serving cells for which beam failure is detected and evaluation of candidate beam is completed, can be skipped if UL grant is not enough.

### EXAMPLE 2

SR (scheduling request) can be triggered for BSR or for LBT failure recovery or for SCell's beam failure recovery (BFR) or BFR of a TRP (i.e. BFD-RS set) of a serving cell. All pending SR(s) for BSR triggered according to the BSR procedure prior to the MAC PDU assembly shall be cancelled and each respective sr-ProhibitTimer shall be stopped when the MAC PDU is transmitted and this PDU includes a Long or Short BSR MAC CE which contains buffer status up to (and including) the last event that triggered a BSR prior to the MAC PDU assembly. All pending SR(s) for BSR triggered according to the BSR procedure shall be cancelled and each respective sr-ProhibitTimer shall be stopped when the UL grant(s) can accommodate all pending data available for transmission. The MAC entity shall for each pending SR not triggered according to the BSR procedure for a Serving Cell:

1> if this SR was triggered by Pre-emptive BSR procedure prior to the MAC PDU assembly and a MAC PDU containing the relevant Pre-emptive BSR MAC CE is transmitted; or

1> if this SR was triggered by beam failure recovery of an SCell and a MAC PDU is transmitted and this PDU includes a BFR MAC CE or a Truncated BFR MAC CE which contains beam failure recovery information for this SCell; or

1> if this SR was triggered by beam failure recovery for a BFD-RS set of a Serving Cell and a MAC PDU is transmitted and this PDU includes an Enhanced BFR MAC CE or a Truncated Enhanced BFR MAC CE which contains beam failure recovery information for this BFD-RS set of the Serving Cell; or

1> if this SR was triggered by beam failure recovery of an SCell and this SCell is deactivated; or

1> if this SR was triggered by beam failure recovery for a BFD-RS set of an SCell and this SCell is deactivated; or

1> if this SR was triggered by beam failure recovery for a BFD-RS set of a PSCell and SCG is deactivated (i.e. UE receives MAC CE or RRC Reconfiguration message indicating SCG is deactivated); or

1> if this SR was triggered by consistent LBT failure recovery of an SCell and a MAC PDU is transmitted and the MAC PDU includes an LBT failure MAC CE that indicates consistent LBT failure for this SCell; or

1> if this SR was triggered by consistent LBT failure recovery of an SCell and all the triggered consistent LBT failure(s) for this SCell are cancelled:
2> cancel the pending SR and stop the corresponding sr-ProhibitTimer, if running.

As long as at least one SR is pending, the MAC entity shall for each pending SR:

1> if the MAC entity has no valid PUCCH resource configured for the pending SR:
2> initiate a Random Access procedure on the SpCell and cancel the pending SR.

1> else, for the SR configuration corresponding to the pending SR:
2> when the MAC entity has an SR transmission occasion on the valid PUCCH resource for SR configured; and
2> if sr-ProhibitTimer is not running at the time of the SR transmission occasion; and
2> if the PUCCH resource for the SR transmission occasion does not overlap with a measurement gap:
   3> if the PUCCH resource for the SR transmission occasion overlaps with neither a UL-SCH resource nor an SL-SCH resource; or
   3> if the MAC entity is able to perform this SR transmission simultaneously with the transmission of the SL-SCH resource; or
   3> if the MAC entity is configured with lch-basedPrioritization, and the PUCCH resource for the SR transmission occasion does not overlap with the PUSCH duration of an uplink grant received in a Random Access Response or with the PUSCH duration of an uplink grant addressed to Temporary C-RNTI or with the PUSCH duration of a MSGA payload, and the PUCCH resource for the SR transmission occasion for the pending SR triggered overlaps with any other UL-SCH resource(s), and the physical layer can signal the SR on one valid PUCCH resource for SR, and the priority of the logical channel that triggered SR is higher than the priority of the uplink grant(s) for any UL-SCH resource(s) where the uplink grant was not already de-prioritized, and the priority of the uplink grant is determined; or
   3> if both sl-PrioritizationThres and ul-PrioritizationThres are configured and the PUCCH resource for the SR transmission occasion for the pending SR triggered overlaps with any UL-SCH resource(s) carrying a MAC PDU, and the value of the priority of the triggered SR determined is lower than sl-PrioritizationThres and the value of the highest priority of the logical channel(s) in the MAC PDU is higher than or equal to ul-PrioritizationThres and the MAC PDU is not prioritized by upper layer; or
   3> if a SL-SCH resource overlaps with the PUCCH resource for the SR transmission occasion for the pending SR triggered, and the MAC entity is not able to perform this SR transmission simultaneously with the transmission of the SL-SCH resource, and either transmission on the SL-SCH resource is not prioritized or the priority value of the logical channel that triggered SR is lower than ul-PrioritizationThres, if configured; or
   3> if a SL-SCH resource overlaps with the PUCCH resource for the SR transmission occasion for the pending SR triggered, and the MAC entity is not able to perform this SR transmission simultaneously with the transmission of the SL-SCH resource, and the priority of the triggered SR determined is higher than the priority of the MAC PDU determined for the SL-SCH resource:
      4> consider the SR transmission as a prioritized SR transmission.
      4> consider the other overlapping uplink grant(s), if any, as a de-prioritized uplink grant(s);
      4> if the de-prioritized uplink grant(s) is a configured uplink grant configured with autonomousTx whose PUSCH has already started:
         5> stop the configuredGrantTimer for the corresponding HARQ process of the de-prioritized uplink grant(s).
      4> if SR_COUNTER<sr-TransMax:
         5> instruct the physical layer to signal the SR on one valid PUCCH resource for SR;
         5> if LBT failure indication is not received from lower layers:
         6> increment SR_COUNTER by 1;
         6> start the sr-ProhibitTimer.
         5> else if lbt-FailureRecoveryConfig is not configured:
         6> increment SR_COUNTER by 1.
      4> else:
         5> notify RRC to release PUCCH for all Serving Cells;
         5> notify RRC to release SRS for all Serving Cells;
         5> clear any configured downlink assignments and uplink grants;
         5> clear any PUSCH resources for semi-persistent CSI reporting;
         5> initiate a Random Access procedure on the SpCell and cancel all pending SRs.
   3> else:
      4> consider the SR transmission as a de-prioritized SR transmission.

In the above procedure UE needs to determine whether the PUCCH resource is valid or not. In an embodiment of this disclosure, when the MAC entity has pending SR for BFR of BFD-RS set of serving cell and the MAC entity has one or more PUCCH resources overlapping with PUCCH resource for BFR of BFD-RS set of serving cell for the SR transmission occasion:
If the MAC entity has pending SR for SCell beam failure recovery and if PUCCH resource of SCell beam failure recovery overlaps with PUCCH resource for BFR of BFD-RS set of serving cell for the SR transmission occasion:
   Option 1: In an embodiment, the MAC entity considers the PUCCH resource for BFR of BFD-RS set of serving cell as valid and the MAC entity considers the PUCCH resource for SCell beam failure recovery as invalid.
   Option 2: In an embodiment, the MAC entity considers the PUCCH resource for BFR of BFD-RS set of serving cell as valid and considers the PUCCH resource for SCell beam failure recovery as invalid, if the pending SR for BFR of BFD-RS set of serving cell is for SpCell.
   Option 3: In an embodiment, the MAC entity considers the PUCCH resource for SCell beam failure recovery as valid and the MAC entity considers the PUCCH resource for BFR of BFD-RS set of serving cell as invalid.
   Option 4: In an embodiment, network (i.e. gNB) indicates which one (PUCCH resources for SCell BFR or PUCCH resource for BFR of BFD-RS set of serving cell) to consider valid. The MAC entity considers the PUCCH resource for BFR of BFD-RS set of serving cell as valid and the MAC entity considers the PUCCH resource for SCell beam failure recovery as invalid, if network indicates to consider PUCCH resource for BFR of BFD-RS set of serving cell as valid. The MAC entity considers the PUCCH resource for BFR of BFD-RS set of serving cell as invalid and the MAC entity considers the PUCCH resource for SCell beam failure recovery as valid, if network indicates to consider PUCCH resources for SCell BFR as valid.
Else (i.e. if the MAC entity has no pending SR for SCell beam failure recovery or If PUCCH resource of SCell beam failure recovery does not overlap with PUCCH resource for BFR of BFD-RS set of serving cell for the SR transmission occasion, and the PUCCH resource for BFR of BFD-RS set of serving cell overlaps with PUCCH resources for SR triggered for BSR/LBT failure recovery)
   the MAC entity considers the PUCCH resource for BFR of BFD-RS set of serving cell as valid and other overlapping PUCCH resources are considered invalid.

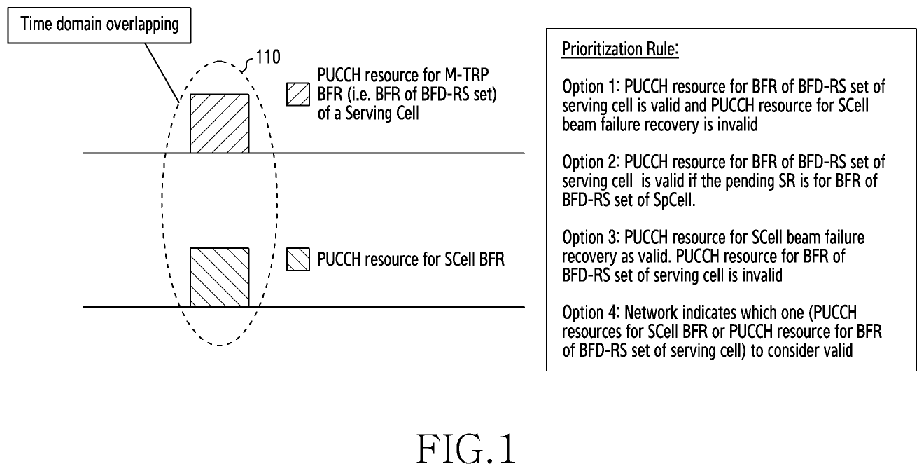

FIG. 1 illustrates an example of PUCCH resource overlapping handling according to an embodiment of the disclosure. FIG. 1 is an example illustration of handling PUCCH resource overlapping according to an embodiment of this disclosure (110). SR is pending for SCell beam failure recovery and SR is also pending for BFR of BFD-RS set of serving cell. PUCCH resource of SCell beam failure recovery overlaps with PUCCH resource for BFR of BFD-RS set of serving cell for the SR transmission occasion. Between PUCCH resource for BFR of BFD-RS set of serving cell and PUCCH resource for SCell BFR:
Option 1: In an embodiment, the MAC entity considers the PUCCH resource for BFR of BFD-RS set of serving cell as valid and the MAC entity considers the PUCCH resource for SCell beam failure recovery as invalid.
Option 2: In an embodiment, the MAC entity considers the PUCCH resource for BFR of BFD-RS set of serving cell as valid and considers the PUCCH resource for SCell beam failure recovery as invalid, if the pending SR for BFR of BFD-RS set of serving cell is for SpCell.
Option 3: In an embodiment, the MAC entity considers the PUCCH resource for SCell beam failure recovery as valid and the MAC entity considers the PUCCH resource for BFR of BFD-RS set of serving cell as invalid.
Option 4: In an embodiment, network (i.e. gNB) indicates which one (PUCCH resources for SCell BFR or PUCCH resource for BFR of BFD-RS set of serving cell) to consider valid. The MAC entity considers the PUCCH resource for BFR of BFD-RS set of serving cell as valid and the MAC entity considers the PUCCH resource for SCell beam failure recovery as invalid, if network indicates to consider PUCCH resource for BFR of BFD-RS set of serving cell as valid. The MAC entity considers the PUCCH resource for BFR of BFD-RS set of serving cell as invalid and the MAC entity considers the PUCCH resource for SCell beam failure recovery as valid, if network indicates to consider PUCCH resources for SCell BFR as valid.

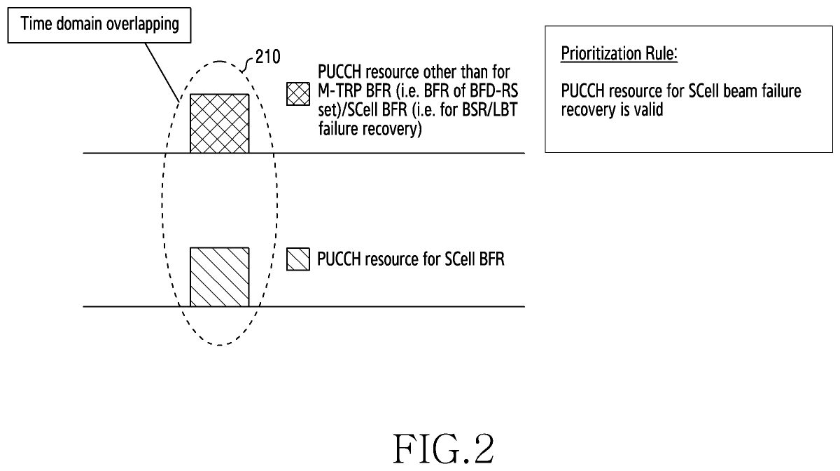

FIG. 2 illustrates another example of PUCCH resource overlapping handling according to an embodiment of the disclosure. FIG. 2 is an example illustration of handling PUCCH resource overlapping according to an embodiment of this disclosure (210). SR is pending for SCell beam failure recovery and SR is also pending for BSR/LBT failure recovery (i.e. for other than that of BFD-RS set of serving cell). PUCCH resource of SCell beam failure recovery overlaps with PUCCH resource for BSR/LBT failure recovery (i.e. for other than that of BFD-RS set of serving cell) for the SR transmission occasion. In this case, the MAC entity considers the PUCCH resource for SCell beam failure recovery as valid and the MAC entity considers the other overlapping PUCCH resources are considered invalid.

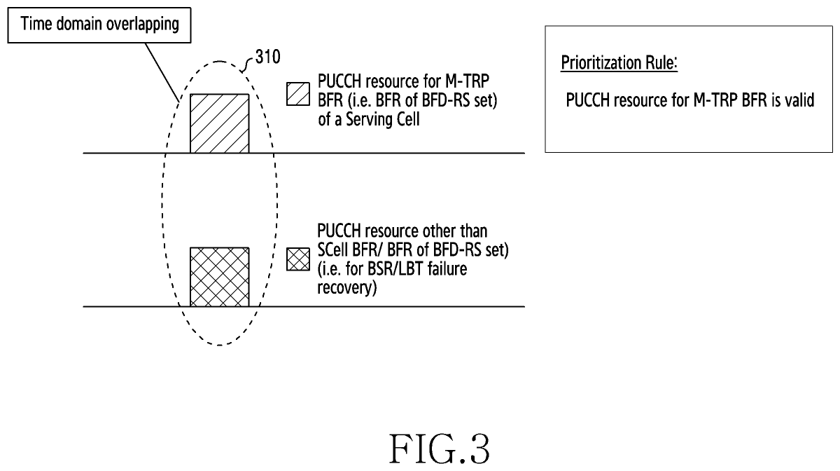

FIG. 3 illustrates another example of PUCCH resource overlapping handling according to an embodiment of the disclosure. FIG. 3 is an example illustration of handling PUCCH resource overlapping according to an embodiment of this disclosure (310). SR is pending for BFR of BFD-RS set of serving cell and SR is also pending for BSR/LBT failure recovery (i.e. for other than that of BFD-RS set of serving cell or for BFR of SCell). PUCCH resource of BFR of BFD-RS set of serving cell overlaps with PUCCH resource for BSR/LBT failure recovery (i.e. for other than that of BFD-RS set of serving cell or for BFR of SCell) for the SR transmission occasion. In this case, the MAC entity considers the PUCCH resource for BFR of BFD-RS set of serving cell as valid and the MAC entity considers the other overlapping PUCCH resources are considered invalid.

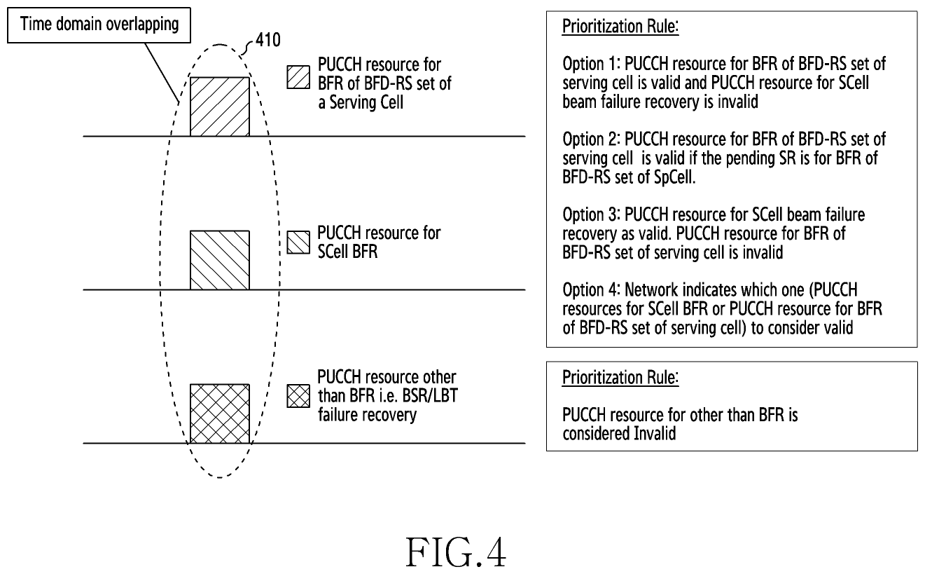

FIG. 4 illustrates another example of PUCCH resource overlapping handling according to an embodiment of the disclosure. FIG. 4 is an example illustration of handling PUCCH resource overlapping according to an embodiment of this disclosure (410). SR is pending for SCell beam failure recovery and SR is also pending for BFR of BFD-RS set of serving cell and SR is also pending for BSR/LBT failure recovery. PUCCH resource of SCell beam failure recovery overlaps with PUCCH resource for BFR of BFD-RS set of serving cell and with PUCCH resource for BSR/LBT failure recovery for the SR transmission occasion. In this case PUCCH resources for BSR/LBT failure recovery is considered invalid.

According to an embodiment of the disclosure, between PUCCH resource for BFR of BFD-RS set of serving cell and PUCCH resource for SCell BFR:
Option 1: In an embodiment, the MAC entity considers the PUCCH resource for BFR of BFD-RS set of serving cell as valid and the MAC entity considers the PUCCH resource for SCell beam failure recovery as invalid.
Option 2: In an embodiment, the MAC entity considers the PUCCH resource for BFR of BFD-RS set of serving cell as valid and considers the PUCCH resource for SCell beam failure recovery as invalid, if the pending SR for BFR of BFD-RS set of serving cell is for SpCell.
Option 3: In an embodiment, the MAC entity considers the PUCCH resource for SCell beam failure recovery as valid and the MAC entity considers the PUCCH resource for BFR of BFD-RS set of serving cell as invalid.
Option 4: In an embodiment, network (i.e. gNB) indicates which one (PUCCH resources for SCell BFR or PUCCH resource for BFR of BFD-RS set of serving cell) to consider valid. The MAC entity considers the PUCCH resource for BFR of BFD-RS set of serving cell as valid and the MAC entity considers the PUCCH resource for SCell beam failure recovery as invalid, if network indicates to consider PUCCH resource for BFR of BFD-RS set of serving cell as valid. The MAC entity considers the PUCCH resource for BFR of BFD-RS set of serving cell as invalid and the MAC entity considers the PUCCH resource for SCell beam failure recovery as valid, if network indicates to consider PUCCH resources for S Cell BFR as valid.

### EXAMPLE 3

If UL grant is not available or UL grant is not large enough to accommodate (truncated) BFR MAC CE, SR is triggered for SCell BFR. If PUCCH resource is not configured for SCell BFR, RA procedure is initiated. The MAC entity may stop, ongoing Random Access procedure due to a pending SR for BFR of an SCell, which has no valid PUCCH resources configured, if:
a MAC PDU is transmitted using a UL grant other than a UL grant provided by Random Access Response or a UL grant for the transmission of the MSGA payload, and
this PDU contains a BFR MAC CE or a Truncated BFR MAC CE which includes beam failure recovery information of that SCell.

Hereinafter, a scenario with two sets of BFR MAC CEs will be described. First set includes truncated BFR MAC CE and BFR MAC CE. Second set includes truncated enhanced BFR MAC CE and enhanced BFR MAC CE. The (truncated) BFR MAC CE includes beam failure recovery information of the serving cell (i.e. candidate beam availability indication for beam failure recovery of the serving cell and candidate RS ID of the serving cell if candidate beam is available). The (truncated) Enhanced BFR MAC CE includes beam failure recovery information of the failed TRPs (i.e. BFD-RS sets) of the serving cell. Beam failure recovery information of each failed TRP (i.e. BFD-RS set) consists of candidate beam availability indication for beam failure recovery of the TRP of serving cell, BFD-RS set ID and candidate RS ID of the of the failed TRP of serving cell serving cell if candidate beam is available.

There are two types of SR for BFR. SR for BFR of SCell and SR for BFD-RS set of Serving Cell (Serving Cell can be SCell or SpCell). RA Cancellation criteria should be able to distinguish these MAC CEs and types of SR. Otherwise SR triggered for SCell BFR can be cancelled when (truncated) enhanced BFR MAC CE for BFR of BFD-RS set is transmitted in MAC PDU. SR triggered for BFR of BFD-RS set of serving cell can be cancelled when (truncated) BFR MAC CE for BFR of SCell is transmitted in MAC PDU.

According to an embodiment of the disclosure, it is proposed to define following new RA cancellation triggers as follows.

Multiple transmission reception points (M-TRP) can be there in a serving cell. BFD/BFR is performed per TRP. In a serving cell supporting multiple TRPs, separate BFD-RS set (or BFD-RSs) and separate candidate beam list for each TRP is signaled by gNB. BFD-RS set refers to BFD-RSs which the UE measures for beam failure detection. A beam failure is detected for a TRP (i.e. BFD-RS set) of a serving cell if number of consecutive detected beam failure instances for the TRP (i.e. BFD-RS set) exceeds a configured maximum number (beamFailureInstanceMaxCount) within a configured time (beamFailureDetectionTimer). Parameters including beamFailureDetectionTimer and beamFailureInstanceMaxCount are configured/signaled by gNB separately for each TRP (i.e. BFD-RS set) of serving cell. BeamFailureDetectionTimer is configured/signaled by gNB separately for each TRP (i.e. BFD-RS set) of serving cell. BeamFailurelnstanceMaxCount is configured/signaled by gNB separately for each TRP (i.e. BFD-RS set) of serving cell. A Beam Failure Instance for a TRP (i.e. BFD-RS set) means that hypothetical PDCCH BLER (block error rate) determined based on measurement of beam failure detection RS is above a threshold for all beam failure detection RSs of the TRP (i.e. BFD-RS set). Upon beam failure instance for a TRP (i.e. BFD-RS set), lower layer i.e. PHY (physical) sends indication to MAC. MAC entity in UE performs the following operation for each serving cell configured with multiple TRPs i.e. BFD-RS sets (note that beam failure detection is not performed for SCells (other than PSCell) of SCG when SCG state is deactivated).

The MAC entity shall for each Serving Cell configured for beam failure detection:

1> if the Serving Cell is configured with multiple BFD-RS sets, the MAC entity shall for each BFD-RS set of this Serving Cell:
2> if beam failure instance indication for a BFD-RS set has been received from lower layers:
   3> start or restart the beamFailureDetectionTimer corresponding to the BFD-RS set;
   3> increment BFI COUNTER corresponding to the BFD-RS set by 1;
   3> if BFI_COUNTER corresponding to the BFD-RS set>=beamFailureInstanceMaxCount:
      4> if the Serving Cell is PSCell:
         5> trigger a BFR for this BFD-RS set of the Serving Cell, if SCG is activated (i.e. scg-State of SCG is set to activated in the SCG configuration);
      4> else:
         5> trigger a BFR for this BFD-RS set of the Serving Cell;
BFR is triggered for a BFD-RS set of serving cell and evaluation of candidate beam is completed.
UL SCH resources are not available or UL SCH resources are available but can accommodate neither enhanced BFR MAC CE nor or truncated enhanced BFR MAC CE. SR is triggered for BFR of BFD-RS set of serving cell.
Valid PUCCH resources are not configured/available for triggered SR. RA procedure is initiated.
The MAC entity may stop, ongoing Random Access procedure due to a pending SR triggered by BFR for a BFD-RS set of a serving cell, which has no valid PUCCH resources configured, if:
   a MAC PDU is transmitted using a UL grant other than a UL grant provided by Random Access Response or a UL grant determined for the transmission of the MSGA payload, and
   this PDU contains an Enhanced BFR MAC CE or a Truncated enhanced BFR MAC CE which includes beam failure recovery information for this BFD-RS set of the serving cell.
The MAC entity may stop, if any, ongoing Random Access procedure due to a pending SR triggered by BFR for a BFD-RS set of an SCell, which has no valid PUCCH resources configured, if:
   the SCell is deactivated and all triggered BFRs for BFD-RS sets of SCells are cancelled.
The MAC entity may stop, if any, ongoing Random Access procedure due to a pending SR triggered by BFR for a BFD-RS set of an PSCell, which has no valid PUCCH resources configured:
   if SCG is deactivated (i.e. UE receives MAC CE or RRC Reconfiguration message indicating SCG is deactivated).

The (truncated) BFR MAC CE includes beam failure recovery information of the serving cell (i.e. candidate beam availability indication for beam failure recovery of the serving cell and candidate RS ID of the serving cell if candidate beam is available). The (truncated) Enhanced BFR MAC CE includes beam failure recovery information of the failed TRPs (i.e. BFD-RS sets) of the serving cell. Beam failure recovery information of each failed TRP (i.e. BFD-RS set) consists of candidate beam availability indication for beam failure recovery of the TRP of serving cell, BFD-RS set ID and candidate RS ID of the of the failed TRP of serving cell serving cell if candidate beam is available. In case of truncated BFR MAC CE, beam failure recovery information for one or more serving cells for which beam failure is detected and evaluation of candidate beam is completed, can be skipped if UL grant is not enough. In case of truncated enhanced BFR MAC CE, beam failure recovery information for one or more BFD-RS sets (or TRPs) of one or more serving cells for which beam failure is detected and evaluation of candidate beam is completed, can be skipped if UL grant is not enough.

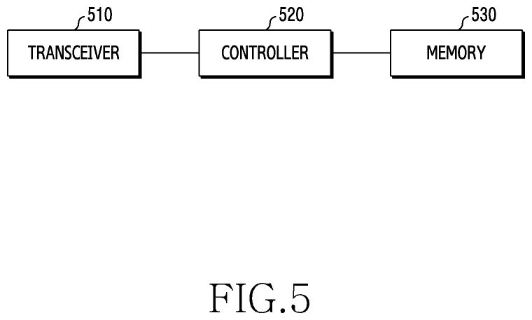

FIG. 5 is a block diagram of a terminal according to an embodiment of the disclosure.

Referring to FIG. 5, a terminal includes a transceiver 510, a controller 520 and a memory 530. The controller 520 may refer to a circuitry, an application-specific integrated circuit (ASIC), or at least one processor. The transceiver 510, the controller 520 and the memory 530 are configured to perform the operations of the UE illustrated in the figures (e.g., FIGS. 1 to 4) or described above. Although the transceiver 510, the controller 520 and the memory 530 are shown as separate entities, they may be realized as a single entity like a single chip. Or, the transceiver 510, the controller 520 and the memory 530 may be electrically connected to or coupled with each other.

The transceiver 510 may transmit and receive signals to and from other network entities, e.g., a base station.

The controller 520 may control the UE to perform functions according to one of the embodiments described above.

In an embodiment, the operations of the terminal may be implemented using the memory 530 storing corresponding program codes. Specifically, the terminal may be equipped with the memory 530 to store program codes implementing desired operations. To perform the desired operations, the controller 520 may read and execute the program codes stored in the memory 530 by using a processor or a central processing unit (CPU).

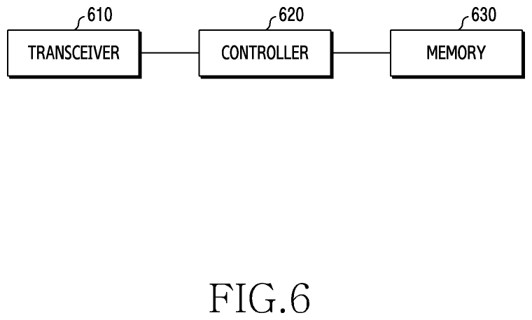

FIG. 6 is a block diagram of a base station according to an embodiment of the disclosure.

Referring to FIG. 6, a base station includes a transceiver 610, a controller 620 and a memory 630. The transceiver 610, the controller 620 and the memory 630 are configured to perform the operations of the network (e.g., gNB) illustrated in the figures (e.g., FIGS. 1 to 4) or described above. Although the transceiver 610, the controller 620 and the memory 630 are shown as separate entities, they may be realized as a single entity like a single chip. The transceiver 610, the controller 620 and the memory 630 may be electrically connected to or coupled with each other.

The transceiver 610 may transmit and receive signals to and from other network entities, e.g., a terminal.

The controller 620 may control the base station to perform functions according to one of the embodiments described above. The controller 620 may refer to a circuitry, an ASIC, or at least one processor. In an embodiment, the operations of the base station may be implemented using the memory 630 storing corresponding program codes. Specifically, the base station may be equipped with the memory 630 to store program codes implementing desired operations. To perform the desired operations, the controller 620 may read and execute the program codes stored in the memory 630 by using a processor or a CPU.

While the disclosure has been shown and described with reference to various embodiments thereof, it will be understood by those skilled in the art that various changes in form and details may be made therein without departing from the scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

Methods according to embodiments stated in claims and/or specifications of the disclosure may be implemented in hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which is accessible through communication networks such as the Internet, Intranet, local area network (LAN), wide area network (WAN), and storage area network (SAN), or a combination thereof. Such a storage device may access the electronic device via an external port. Further, a separate storage device on the communication network may access a portable electronic device.

In the above-described detailed embodiments of the disclosure, a component included in the disclosure is expressed in the singular or the plural according to a presented detailed embodiment. However, the singular form or plural form is selected for convenience of description suitable for the presented situation, and various embodiments of the disclosure are not limited to a single element or multiple elements thereof. Further, either multiple elements expressed in the description may be configured into a single element or a single element in the description may be configured into multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
identifying that a first physical uplink control channel (PUCCH) resource for a first pending scheduling request (SR) associated with a beam failure recovery and a second PUCCH resource for a second pending SR different from the first pending SR overlap; and
transmitting, to a base station, an SR in one of the first PUCCH resource and the second PUCCH resource,
wherein, in case that the first PUCCH resource is for a secondary cell (SCell) beam failure recovery and the second PUCCH resource is not for a beam failure recovery of beam failure detection (BFD) reference signal (RS) set, the SR is transmitted in the first PUCCH resource.

2. The method of claim 1, wherein, in case that the first PUCCH resource is for the beam failure recovery of the BFD RS set of a serving cell and the second PUCCH resource is not for a beam failure recovery, the SR is transmitted in the first PUCCH resource.

3. The method of claim 1, wherein, in case that the first PUCCH resource is for the SCell beam failure recovery and the second PUCCH resource is for the beam failure recovery of the BFD RS set, the SR is transmitted in the first PUCCH resource.

4. The method of claim 1, wherein, in case that the first PUCCH resource is for the SCell beam failure recovery and the second PUCCH resource is for the beam failure recovery of the BFD RS set, the SR is transmitted in the second PUCCH resource.

5. The method of claim 1, wherein the first PUCCH resource is considered as valid.

6. A method performed by a base station in a wireless communication system, the method comprising:
receiving, from a terminal, a scheduling request (SR),
wherein, in case that a first physical uplink control channel (PUCCH) resource for a first pending scheduling request (SR) associated with a beam failure recovery and a second PUCCH resource for a second pending SR different from the first pending SR overlap, the SR is received in one of the first PUCCH resource and the second PUCCH resource, and
wherein, in case that the first PUCCH resource is for a secondary cell (SCell) beam failure recovery and the second PUCCH resource is not for a beam failure recovery of beam failure detection (BFD) reference signal (RS) set, the SR is received in the first PUCCH resource.

7. The method of claim 6, wherein, in case that the first PUCCH resource is for the beam failure recovery of the BFD RS set of a serving cell and the second PUCCH resource is not for a beam failure recovery, the SR is received in the first PUCCH resource.

8. The method of claim 6, wherein, in case that the first PUCCH resource is for the SCell beam failure recovery and the second PUCCH resource is for the beam failure recovery of the BFD RS set, the SR is received in the first PUCCH resource.

9. The method of claim 6, wherein, in case that the first PUCCH resource is for the SCell beam failure recovery and the second PUCCH resource is for the beam failure recovery of the BFD RS set, the SR is received in the second PUCCH resource.

10. The method of claim 6, wherein the first PUCCH resource is considered as valid.

11. A terminal in a wireless communication system, the terminal comprising:
a transceiver; and
a controller coupled with the transceiver and configured to:
identify that a first physical uplink control channel (PUCCH) resource for a first pending scheduling request (SR) associated with a beam failure recovery and a second PUCCH resource for a second pending SR different from the first pending SR overlap, and
transmit, to a base station, an SR in one of the first PUCCH resource and the second PUCCH resource,
wherein, in case that the first PUCCH resource is for a secondary cell (SCell) beam failure recovery and the second PUCCH resource is not for a beam failure recovery of beam failure detection (BFD) reference signal (RS) set, the SR is transmitted in the first PUCCH resource.

12. The terminal of claim 11, wherein, in case that the first PUCCH resource is for the beam failure recovery of the BFD RS set of a serving cell and the second PUCCH resource is not for a beam failure recovery, the SR is transmitted in the first PUCCH resource.

13. The terminal of claim 11, wherein, in case that the first PUCCH resource is for the SCell beam failure recovery and the second PUCCH resource is for the beam failure recovery of the BFD RS set, the SR is transmitted in the first PUCCH resource.

14. The terminal of claim 11, wherein, in case that the first PUCCH resource is for the SCell beam failure recovery and the second PUCCH resource is for the beam failure recovery of the BFD RS set, the SR is transmitted in the second PUCCH resource.

15. The terminal of claim 11, wherein the first PUCCH resource is considered as valid.

16. A base station in a wireless communication system, the base station comprising:
a transceiver; and
a controller coupled with the transceiver and configured to:
receive, from a terminal, a scheduling request (SR),
wherein, in case that a first physical uplink control channel (PUCCH) resource for a first pending scheduling request (SR) associated with a beam failure recovery and a second PUCCH resource for a second pending SR different from the first pending SR overlap, the SR is received in one of the first PUCCH resource and the second PUCCH resource, and
wherein, in case that the first PUCCH resource is for a secondary cell (SCell) beam failure recovery and the second PUCCH resource is not for a beam failure recovery of beam failure detection (BFD) reference signal (RS) set, the SR is received in the first PUCCH resource.

17. The base station of claim 16, wherein, in case that the first PUCCH resource is for the beam failure recovery of the BFD RS set of a serving cell and the second PUCCH resource is not for a beam failure recovery, the SR is received in the first PUCCH resource.

18. The base station of claim 16, wherein, in case that the first PUCCH resource is for the SCell beam failure recovery and the second PUCCH resource is for the beam failure recovery of the BFD RS set, the SR is received in the first PUCCH resource.

19. The base station of claim 16, wherein, in case that the first PUCCH resource is for the SCell beam failure recovery and the second PUCCH resource is for the beam failure recovery of the BFD RS set, the SR is received in the second PUCCH resource.

20. The base station of claim 16, wherein the first PUCCH resource is considered as valid.
